(19) United States
(12) Patent Application Publication
(10) Pub. No.: US 2011/0192544 A1
(43) Pub. Date: Aug. 11, 2011

(54) APPARATUS FOR MANIPULATING AND SHAPING ADHEREABLE ARTS AND CRAFTS BUILDING ELEMENTS

(76) Inventor: Paul Andrew Reynolds, Toronto (CA)

(21) Appl. No.: 12/701,190

(22) Filed: Feb. 5, 2010

(51) Int. Cl. B29C 39/10; B65D 83/00; B25B 11/00; B66C 1/02

(52) U.S. Cl. 156/500; 221/64

(57) ABSTRACT

A mould for creating a finished article from adherent building elements such as fusible beads. The mould includes a mould core, which may be removable; one or more female mould portions surrounding the core so as to define a cavity between the core and the one or more female mould portions; and at least one opening for ingress of adherent building elements into the cavity and introduction of a fusing agent in order to bond together the adherent building elements. A tool for selectively picking up and dispensing the adherent building elements is also disclosed. The tool is provided in the form of a squeezable container having a spout and one-way air valve for creating suction to pick up the adherent elements, and then selectively dispense them.

### FIELD OF THE INVENTION

The invention relates generally to the field of arts and crafts, and more particularly to apparatus and methods for forming sculptures utilizing small adhered building block elements such as fusible beads.

### BACKGROUND OF THE INVENTION

PixOs™ crafts sets permit one to create artwork from small beads that will stick to each other if lightly sprayed with water and allowed to dry. The sets include a quantity of the small beads and typically further include one or more dimpled trays sized on which the beads are positioned to form a design. The dimples are spaced to hold the beads in close proximity to one another so that they stick or fuse together when sprayed with water (e.g., from a spray bottle) and thereafter dried. The sets also typically come with one or more design templates that can be situated underneath the trays (which are transparent) so as to assist the user in forming pre-designed artwork. An example is shown in FIG. 1, where variously coloured beads 12 may be arranged in dimples 14 of tray 16 in a representation of a peacock, per template 18. Of course, any design may be created and the dimpled trays are provided in either a flat stature for creating two dimensional structures or in a somewhat concave stature in order to enable the user to create simple three dimensional structures that can stand on their own. Once the fusible beads have joined together they collectively form either a flat or somewhat curvilinear flexible sheet that can be lifted from or peeled away from the dimpled tray so that the tray may be reused to create further artwork.

The fusible beads are relatively small and so in order to aid the unsteady and potentially sticky hands of young children in manipulating them (as well as adults with thicker fingers), PixOs™ arts and craft sets may includes a pen-like structure for dispensing the fusible beads one at a time. The pen-like dispenser has an elongate tube terminating in an outlet sized to dispense only one fusible bead, and a gating trigger is provided for selectively releasing the fusible beads. The elongate tube is connected to a chamber that stores many fusible beads, and the pen-like device may be shaken to urge the fusible beads from the chamber into the elongate tube so that the beads may be subsequently dispensed. PixOs™ arts and craft sets may also include another pen-like structure that features a tip resembling an eraser. The eraser tip is somewhat tacky in nature in order to latch onto and remove a fusible bead from the dimpled tray—thus enabling the child to ‘erase’ any errantly placed fusible beads.

It is desirable to increase the usage scope of the fusible beads in order to extend the range of creativity and play.

### SUMMARY OF THE INVENTION

Generally speaking, the invention extends the usage of adherent building elements such as the PixOs™ fusible beads by providing a mould that enables such elements to be formed into far more complex shapes.

According to one aspect of the invention, a mould is provided for creating a finished article from a plurality of adherent building elements. The mould includes a mould core; at least one female mould portion surrounding the core so as to define a cavity between the core and the at least one female mould portion; and at least one opening in at least one female mould portion for ingress of adherent building elements into the cavity and introduction of a fusing agent in order to bond together the adherent building elements.

In some embodiments, two or more female mould portions are provided. The at least one opening may be defined in one or more female mould portions.

The adherent building elements can be fusible beads and the fusing agent can be a liquid. In this case, the mould preferably includes one or more drainage holes for draining excess fusing agent out of the cavity.

The walls defining the cavity can include a series of ridges thereon. At least a portion of the ridges may be orientated transverse to the opening and sized to distribute fusing agent across the breadth of the mould. In addition, at least a portion of the ridges may be orientated generally parallel to the opening and sized to direct fusing agent towards the drainage holes.

The opening into the mould is preferably a funnel that is formed when two female mould portions are close together. The funnel fluidly communicates with the mould cavity and is sized to enable the ingress of the adherent building elements into the cavity and for the introduction of the fusing agent into the mould cavity. Each female mould portion may include a frusto-conical section that cooperates with another female mould portion to collectively define the funnel. Drainage holes may be provided for the mould that are separate from the opening used to introduce the building elements into the cavity. Alternatively, the one or more openings used for the introduction of building elements and/or fusing material may be used for the egress of liquid from the mould cavity (eg. by inverting the mould after a selected period of time) to drain any liquid).

The mould may include a platform upon which the mould core is seated or integrally formed therewith, and each female mould portion may be pivotally mounted to the platform.

The mould core may be integrally formed with the mould or may be removably mounted to the platform. In the latter case, the mould core may, for instance, represent a character and adhered building elements can cover or clothe at least a portion of the mould core when it is removed from the mould.

The mould may include a stand, and the platform may be seated horizontally on the stand or orientated vertically relative to the stand.

According to another aspect of the invention, a tool is provided for picking up and dispensing small objects such as fusible beads. The tool includes a resiliently deformable container having a spout with an opening leading to the interior of the container and a one-way air valve having an inlet within the container and an outlet external of the container. The spout and its opening are configured to enable a suction force for picking up the small objects when the container expands back to its original state after being squeezed.

The tool preferably includes a base and a sidewall connected to the base. The base defines an edge thereof. The sidewall preferably has a concave portion that bulges outwardly relative to the edge of the base and a concave portion extending inwardly relative to the edge of the base. The concave sidewall portion is preferably connected to the convex sidewall portion and the concave sidewall portion defines at least a portion of the spout. As a result of such a sidewall shape the tool presents a gravitational well at certain orientations thereof in order to preclude small objects entrained in the tool from reaching the spout when it is directed downwardly to pick up an external small object via the suction force. The gravitation well is preferably not present at other orientations of the container so that entrained small objects may be dispensed out of the spout when the spout is directed downwardly.

### BRIEF DESCRIPTION OF THE DRAWINGS

The foregoing and other aspects of the invention will be better appreciated with reference to the following drawings provided for the purpose of illustration, wherein:

FIG. 1 is a schematic diagram of a prior art PixOs™ dimpled tray and a design template for guiding users to arrange PixOs™ fusible beads of in the form of pre-designated artwork;

FIG. 2 is a perspective view of a three dimensional mould according to a first embodiment for moulding adherent building block elements such as fusible beads in the form of a popsicle;

FIG. 3 is a perspective view of the mould shown in FIG. 1 taken from an opposing point of view;

FIG. 4 is a side view of the mould shown in FIG. 1;

FIG. 5 is an exploded side elevation view of the mould shown in FIG. 1;

FIG. 6 is a perspective view of the mould shown in FIG. 1 in an open state;

FIG. 7 is a perspective view of a hollow article manufactured by the mould shown in FIG. 1 and an accessory piece upon which the article sits;

FIG. 8 is a perspective view of a mould according to a variant of the first embodiment wherein the mould has a removable core;

FIG. 9 is a perspective view of a three dimensional mould according to a second embodiment for moulding adherent building block elements such as fusible beads in the form of a character;

FIG. 10 is a perspective view of a character that is formed in part by the mould shown in FIG. 8;

FIG. 11 is a plan view of a tool for selectively picking up and selectively dispensing fusible beads;

FIGS. 12A and 12B are schematic diagrams demonstrating how the tool illustrated in FIG. 10 may be used;

FIGS. 13A and 13B are sectional views of the tool, illustrating a one-way valve;

FIG. 14 is a perspective view of a mould in accordance with another embodiment of the present invention; and

FIG. 15 is a perspective view of a moulded product made in the mould shown in FIG. 14.

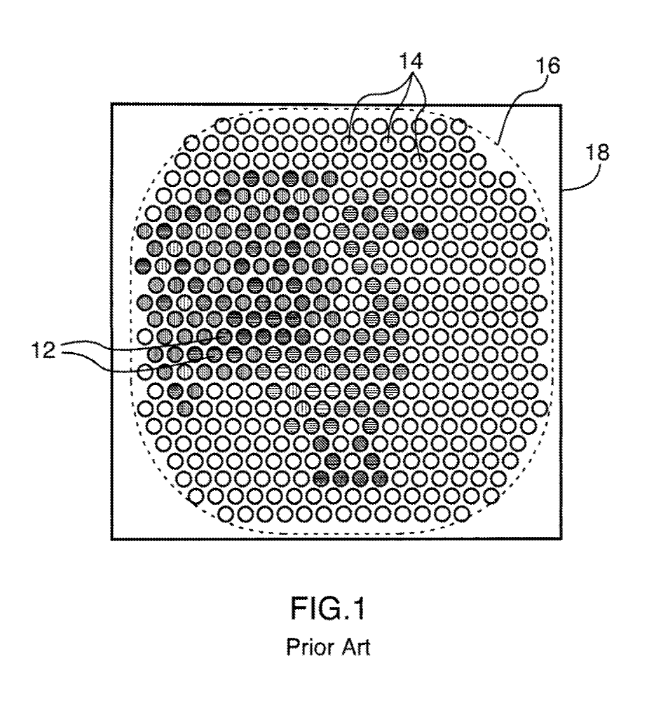

### DETAILED DESCRIPTION OF PREFERRED EMBODIMENTS

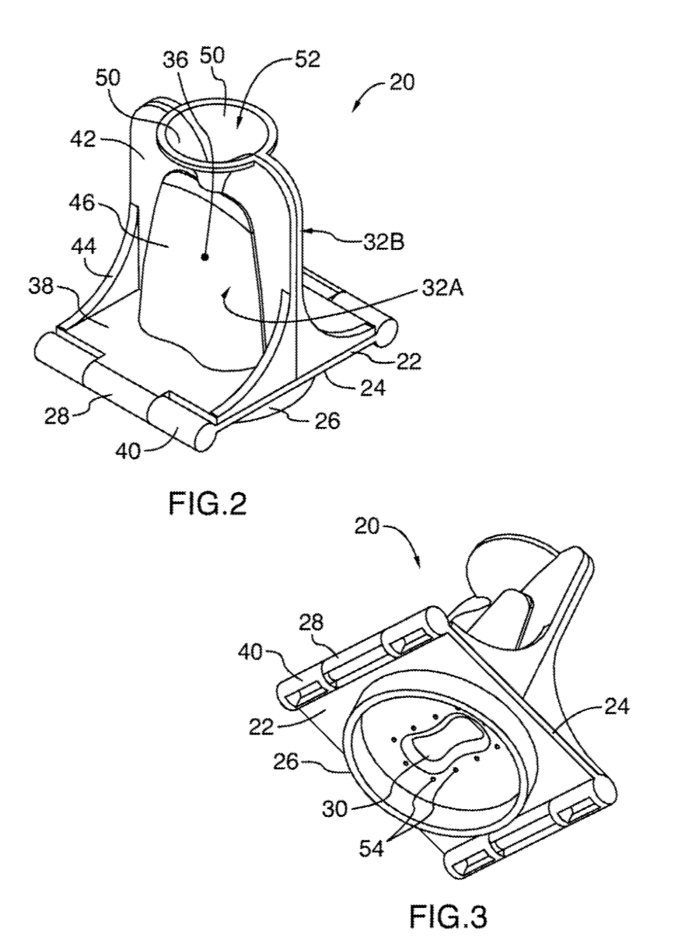

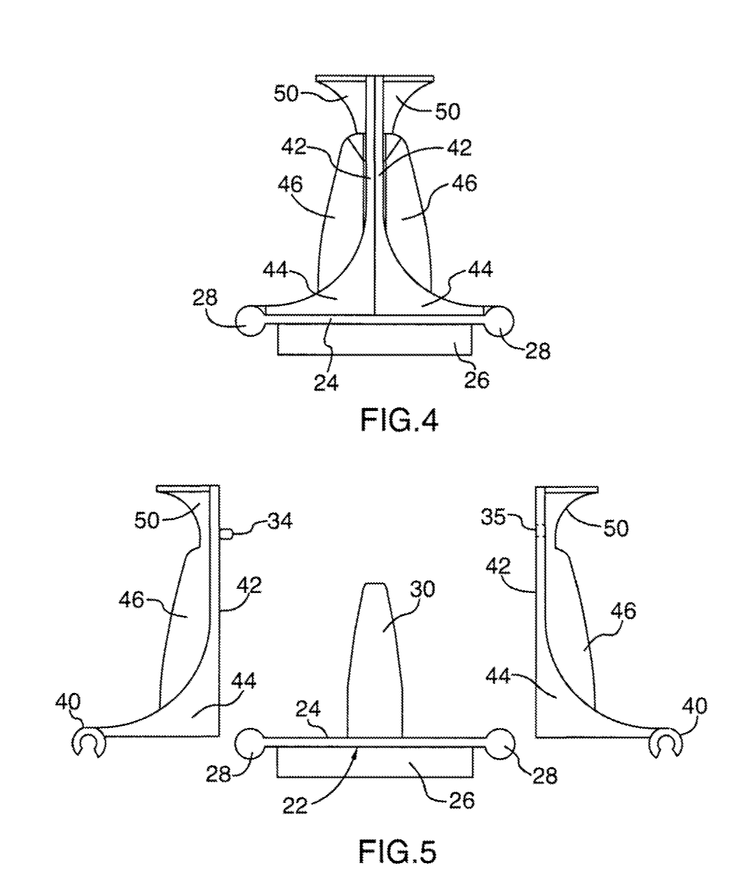

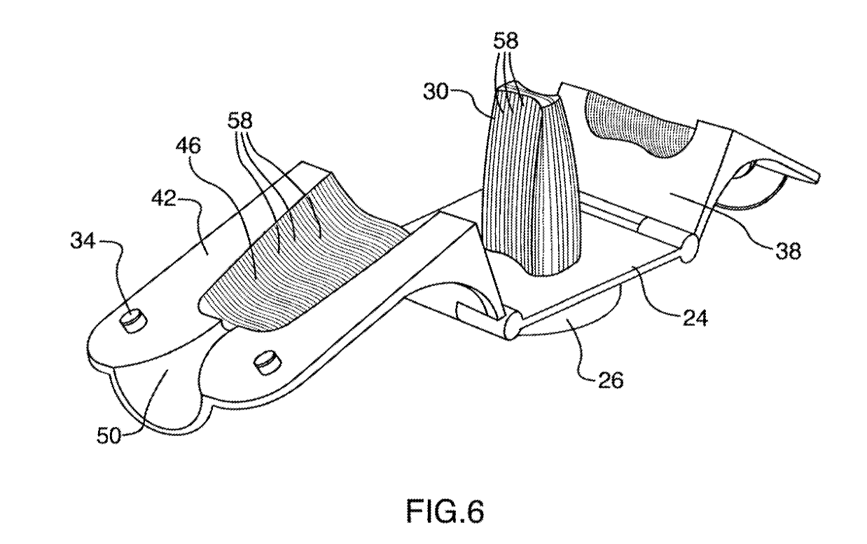

FIGS. 2 and 3 show top and bottom isometric views of an exemplary mould 20 for creating complex three dimensional articles with adherent building elements such as fusible PixOs™ beads. FIG. 4 is a side view of the mould 20; FIG. 5 is an exploded side elevation view of the mould 20, and FIG. 6 is a perspective view of the mould 20 in an open state.

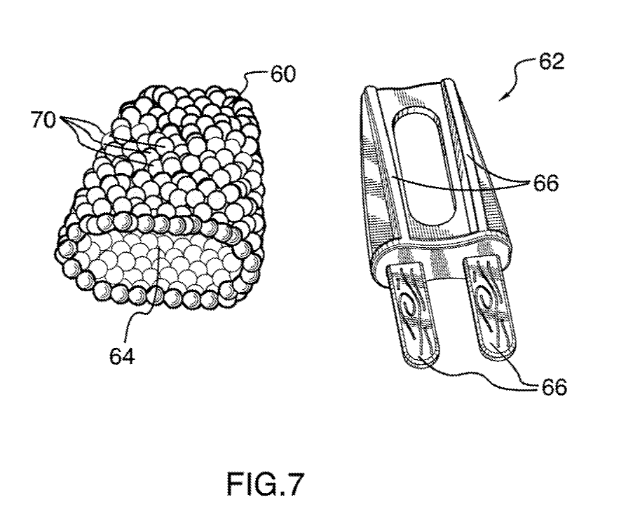

In the illustrated example, and with further reference to FIG. 7, the mould 20 is utilized to create a complex three dimensional shape from fusible beads 70. In the illustrated example, the fusible beads 70 are moulded in mould 20 to create a shell 60 resembling the edible portion of a popsicle. The shell 60 is intended to clothe or otherwise be fitted onto an accessory piece such as a popsicle mount 62. More specifically, the shell 60 has a hollow portion 64 for mounting onto a supporting section 66 of the popsicle mount 62, leaving handles 68 uncovered.

Mould 20 has a base 22 comprising a plate or platform 24 seated on a circular stand 26. (The platform 24 in this embodiment is oriented horizontally relative to the circular stand 26 but it need not be as demonstrated with a second embodiment discussed below.) The platform 24 features opposing cylindrical end portions 28 that form part of a hinge, as discussed in greater detail below. In mould 20, a male portion of the mould or core 30 (seen best in FIGS. 5 and 6) sits upon and is preferably integrally formed with the platform 24.

The core 30 is surrounded by two female mould portions 32, shown individually at 32A, 32B. The female mould portions may be referred to as mould halves even though they do not necessarily occupy half of the mould and are not necessarily the same size as each other. The female mould portions collectively define a cavity 36 establishing the shape of the finished article, such as shell 60.

In some embodiments, each female mould half 32 features a first plate 38 that may in operation sits flush against the platform 24 of base 22 when the mould 20 is closed. Alternatively there may be a gap between each female mould portion 32 and the base 22 so as to inhibit the adhering of the female mould portions 32 and the base 22 together by adhesive that comes off the building elements when they are wetted (in embodiments where the building elements 70 have adhesive thereon). The first plate 38 terminates in a C-shaped section 40 that wraps around one of the cylindrical end portions 28 of the platform 24 in order to form a hinge, thus enabling the female mould halves 32A, 32B to pivot and open the mould as seen in FIG. 6. Instead of having the female and male mould portions be separate, it is alternatively possible to have them be integrally connected to each other through a living hinge.

Each female mould half 32A, 32B also features a second plate portion 42 that is orientated substantially perpendicularly to the first plate portion 38. The second plate portions 42 of the two female mould halves 32A, 328 may abut one another in operation to form a Parting line for the mould. The abutment may be along substantially the entire surfaces of the second plate portions 42 as shown in the figures. Alternatively one or both of the plate portions 42 may have a raised sealing surface that immediately surrounds the mould and is relatively thin so as to occupy a small portion of the overall surface area of the plate portion 42 on which it is present. In this way, when the plate portions abut each other along a thin raised edge surface so as to leave the majority of their facing surfaces spaced from one another by a small gap to inhibit their adhering to one another by adhesive that comes off the building elements 70 when they are wetted (in embodiments where the building elements 70 have adhesive thereon). One of the female mould halves 32A can include one or more pins 34 on the second plate portion 42 that mate with correspondingly disposed holes 35 on the second plate portion 42 of the other female mould half 32B so as to provide a slight snap fit for releasably locking the two female mould halves together.

Optional ribs 44 enhance rigidity between the first and second plate portions 38, 42 of each mould half 32.

Each female mould half 32 also includes a contour portion 46 integrally formed with and between the first and second plate portions 38, 42. The contour portion 46 defines the outer contour of the finished article.

Each female mould half 32 also includes an inlet half section 50. When the mould 20 is closed, the inlet half sections 50 collectively provide a funnel 52 having a relatively wide opening at its top end that tapers into a narrower opening leading into the cavity 36.

It will thus be seen that the mould 20 may be manufactured out of three relatively simple plastic parts, two of which may be identical or nearly identical. These parts can be formed through injection moulding as known in the art per se.

The adherent building elements such as fusible PixOs™ beads are introduced into the mould cavity 36 via the funnel 52 and will, under gravity, flow into and fill the cavity 36. The wide top opening of the funnel 52 may accommodate a number of adherent building elements whilst the narrow bottom opening of the funnel 52 may be sized to allow the passage of only one or a relatively small number of adherent building elements therethrough at a time to thus allow for a more controlled ingress of the adherent building elements into the cavity 36.

The thickness of the cavity 36 (i.e., in this embodiment, the spacing between the walls of core 30 and contour portion 46 of female mould half 32) may vary depending on the desired thickness of the finished article. For instance, the cavity 36 may have a thickness only slightly larger than the width of the adherent building element if the finished article is desired to be formed from a single layer mesh of the adherent building elements. Alternatively, the cavity 36 may have a greater thickness so that the finished article is formed from a staggered layer arrangement of the adherent building elements as illustrated in FIG. 7.

The fusing agent for the building elements—water in the case of PixOs™ fusible beads—is also conveniently introduced into the cavity 36 via the funnel 52. In the case of PixOs™ elements water can be poured into the mould 20 from a cup or other vessel, as opposed to spraying tiny droplets of water from a spray pump as is done for two dimensional designs on a dimpled tray. A series of small holes 54 may be provided in the platform 24 of base 22 in order to enable excess fusing agent to drain out of the cavity 36. Alternatively the excess water may be drained from the cavity by inverting the mould and letting the water drain from the funnel 52. The water dissolves a coating of adhesive on the PixOs™ elements. Once the water evaporates or is otherwise removed, the adhesive dries and connects together any PixOs elements that are in contact with one another.

As illustrated in FIG. 6 the outer cavity-forming wall of the core 30 and inner cavity-forming wall of the contour portion 46 of each female mould half 32 are preferably formed with, or scored or otherwise treated to provide, a series of raised elements, such as ridges 58. These ridges 58 can be sized and spaced to contact only the outermost edge of the building elements, so as to reduce the overall surface area of the beads 70 that are in contact with the mould wall through the fusing liquid. This in turn reduces the likelihood of the beads fusing with the wall of the mould cavity (ie. the inner wall of the contour portion 46).

The ridges 58 are separated from each other by channels, which may assist in transporting excess fusing agent away from the building elements, thereby assisting in drying the building elements so that they can form a unitary structure that can be removed from the mould. In the illustrated embodiment the female mould halves 32A, 32B feature horizontally orientated ridges 58, which are separated by channels, which can assist in distributing fusing agent about the periphery of the mould. The core 30 features vertically orientated ridges 58, which facilitate removal of the moulded craft therefrom after the craft (eg. a popsicle) has dried. Additionally, the vertical ridges 58 direct the fusing agent downwardly towards the drainage holes 54. The ridges 58 need not be oriented in any particular direction however. For example, the ridges 58 could be shaped in swirls or waves. Furthermore, the raised portions of the inner wall of the contour portion 46 could alternatively be bumps or some other suitable shape other than ridges.

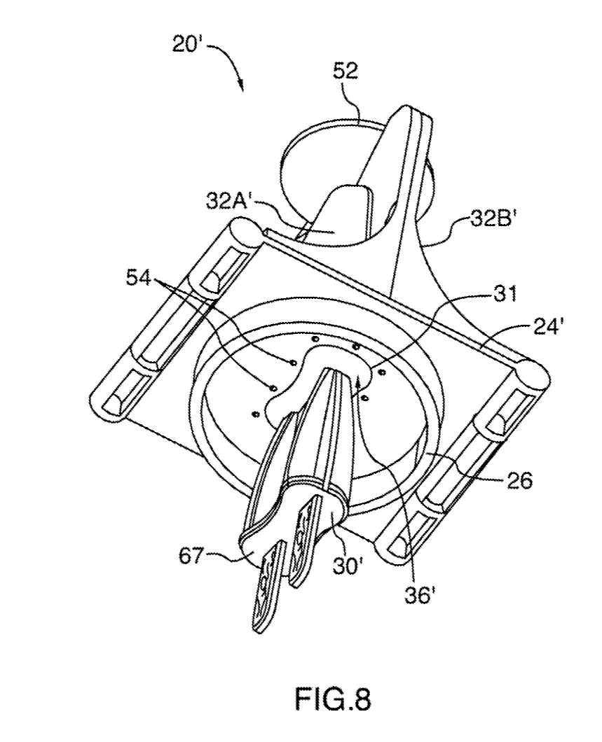

A variant of this embodiment is illustrated in FIG. 8, where mould 20′ features a removable core 30′. In this embodiment, the two female mould halves 32A′ and 32B′ define a larger cavity 36′ and the platform 24′ has an opening 31 therein to accommodate the removable core 30′, which in this case is the accessory piece/popsicle mount 62. The opening 31 in the platform 24′ is sized to snugly receive a base 67 of the removable core 30, and thus the removable core 30′ can be inserted into the platform 24′ (preferably from the top down and not bottom up as shown in the illustration) to provide the male portion of the mould 20′. After moulding, the finished article including the removable core 30′ may be removed from the mould.

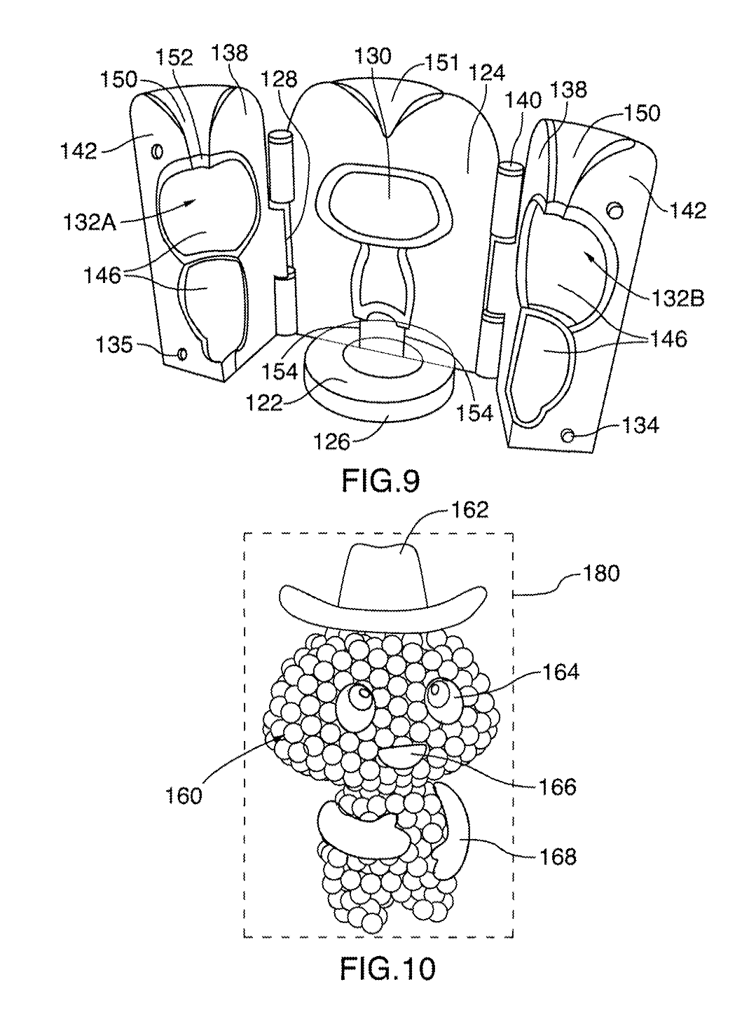

FIG. 9 shows another complex three dimensional shape mould 120 according to a second embodiment that may be used to create from the fusible beads 70 a character 160 such as shown in FIG. 10. More particularly, the character 160 is symmetrical about a bisecting plane 180 (which, in reference to FIG. 9, divides the character into front and rear halves) and the mould 120 is configured to create one half of the character. Thereafter, the character 160 may be formed by applying fusing agent or alternatively adhesive to the adjoining edges of the two characters halves in order to join them together. The user can also attach accessory pieces such as hat 162, eyes 164, mouth 166 and hands 168 to the moulded character 160 by applying an adhesive between the accessory pieces and the moulded character.

Mould 120 has a base 122 comprising a plate or platform 124 seated on a circular stand 126. The platform 124, which in this embodiment is vertically oriented relative to the circular stand 126, features opposing cylindrical end portions 128 that form part of a hinge, as discussed in greater detail below. The male portion of the mould or core 130 is seated on and is preferably integrally formed with the platform 124.

The core 130 is surrounded by two female mould halves 132A, 132B that collectively define a cavity 136 establishing the shape of the finished article, in this case one half of character 160.

More particularly, each female mould half 132 features a first plate 138 that in operation sits flush against the platform 124 when the mould 120 is closed. The first plate 138 terminates in a C-shaped section 140 that wraps around one of the cylindrical end portions 128 of the platform 124 in order to form a hinge, thus enabling the female mould halves 132A, 132B to pivot and open the mould as seen in the open-mould position of FIG. 9.

Each female mould half 132A, 132B also features a second plate portion 142 that is orientated substantially perpendicular to the first plate portion 38. The second plate portions 142 of the two female mould halves 132A, 132B abut one another in operation to form a parting line for the mould. One of the female mould halves 1328 can include one or more pins 134 on the second plate portion 142 that mate with correspondingly disposed holes 135 on the second plate portion 142 of the other female mould half 132A so as to provide a slight snap fit for releasably locking the two female mould halves 132A, 132B together.

Each female mould half 132 also includes a contour portion 146 integrally formed with and between the first and second plate portions 138, 142. The contour portion 146 defines the outer contour of the finished article.

Each female mould half 132 also includes a portion of a frusto-conical section 150, and the platform 124 also includes a portion of a frusto-conical section 151. When the mould 120 is closed, the frusto-conical sections 150,151 collectively provide a funnel 152 having a relatively wide opening at its top end that tapers into a narrower opening leading into the cavity 136.

Mould 120 may thus also be manufactured out of three relatively simple plastic parts, two of which are identical. These parts can be easily formed by injection moulding as known in the art per se.

The adherent building elements such as the fusible PixOs™ beads are introduced into the mould cavity 136 via the funnel 152 and will naturally flow into and fill the cavity 316. The wide top opening of the funnel 152 may accommodate a number of adherent building elements whilst the narrow bottom opening of the funnel 152 may be sized to allow the passage of only one or a relatively few number of adherent building elements therethrough at a time to thus encourage a more controlled ingress of the adherent building elements into the cavity 36.

The thickness of the cavity 136 (i.e., in this embodiment, the spacing between the walls of core 130 and contour portion 146 of female mould half 132) may vary depending on the desired thickness of the finished article, as discussed above.

The fusing agent for the building elements—water in the case of PixOs™ fusible beads—is also conveniently introduced into the cavity 136 via the funnel 152. In the case of PixOs™ elements water may be poured into the mould 120 and drainage channels 154 may be provided in the platform 124 in order to enable excess fusing agent to drain out of the cavity 136.

Although not illustrated in FIG. 9 the cavity-forming wall of the core 130 and the cavity-forming wall of the contour portion 146 of each female mould half 132 may be configured to provide a series of ridges. As discussed above, horizontally orientated ridges may be provided on female contour portion 146 and vertically orientated ridges may be provide on the core 130 to direct the fusing agent downwardly into the drainage holes 154.

A variant of this embodiment, designated herein as mould 120′, may also feature a removable core. In this variant, the two female mould halves 132A, 132B can define a larger cavity therebetween to encompass a removable core shaped in the form of the entire character 160, and the platform 124 can be formed to have an opening therein to accommodate the removable core. After moulding, the finished article including the removable core may be removed from the mould.

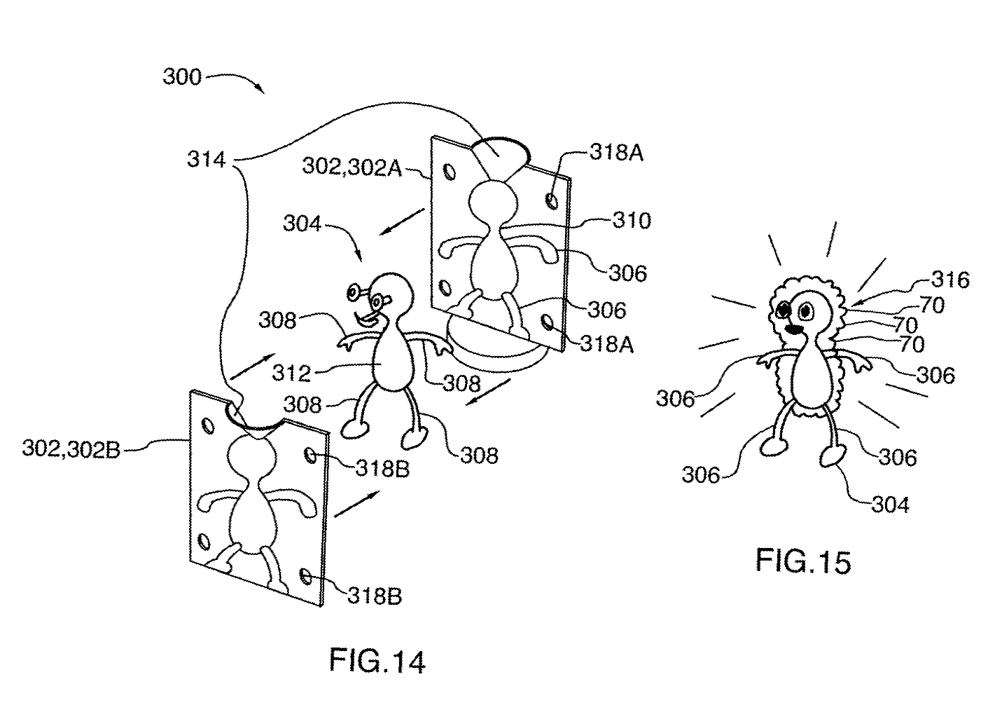

Reference is made to FIG. 14 which shows another embodiment of a mould shown at 300 with a removable core. The mould 300 includes first and second mould halves 302 (shown individually at 302A and 302B) and a core 304. The mould halves 302 together define a mould cavity that includes first cavity portions 306 that fit snugly around first portions 308 of the core 304, and a second cavity portion 310 that surrounds, but is not snug with, a second portion 312 of the core 304. When the mould 300 is closed the core 304 is supported in place by the support of the first cavity portions 306 on the first core portions 308. When the building elements 70 (not shown in FIG. 14, but are shown in FIG. 15) are introduced into the mould 300 through the funnel inlet shown at 314, they accumulate in the space in the second cavity portion 310 around the second core portion 312. The building elements 70 are prevented from entering the first cavity portions 306 by the snug fit between the first cavity portions 306 and the first core portions 308. When the building elements are wetted and dried to fuse them, they form a covering that can substantially completely surround the second core portion 312. When the mould halves 302 are separated and the moulded product (shown at 316 in FIG. 15) is removed it is complete. This saves the further step of rewetting edges on moulded half-products so as to join them together, and makes for a theoretically stronger finished product. While the mould halves 302 are shown as separating completely from each other in the embodiment shown in FIG. 14, it is possible for them to be connected to each other (either integrally or non-integrally) by a hinge so that they can hingedly separate from each other once the moulded product is formed.

It will be noted that in the moulded product 316 the first portions 308 of the core 304 remain exposed. In the embodiment shown, the moulded product 316 is a character figure, and the first portions 308 of the core 304 form the limbs (arms and legs) of the character figure and thus form a useful part of the appearance of the character figure.

The removable core 304 may be provided with selected features for increased entertainment value, such as one or more motion sensitive LEDs so that the moulded product 316 lights up when moved. The light from the LEDs can be emitted through the gaps between the building elements (and/or through the building elements 70 themselves in embodiments where some or all are transparent or translucent).

The mould halves 302 may join together by any suitable means, such as by snaps members 318A and 318B that are integrally moulded into the mould halves 302.

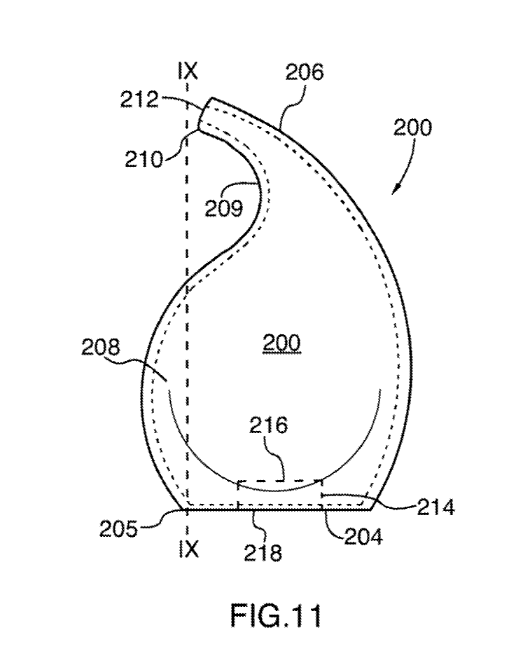

FIG. 11 shows a tool 200 for enabling the user to selectively pick up and dispense fusible beads 70. The tool 200 is preferably formed from a resiliently deformable material such as thin-walled plastic and includes a hollow space 202 for containing the fusible beads 70. A bottom end of the tool 200 has a flat base 204 for resting the tool in an upright position, and the opposite or top end of the tool 200 terminates in a curved spout 206. The sidewall of the tool 200 includes at least one convex portion 208 that bulges outwardly relative to an edge 205 of the base 204 indicated by reference plane IX-IX.

The spout 206 begins at a central portion of the tool and curves gradually towards the plane (IX-IX) defined by the edge 205 of the base 204, resulting in a concave sidewall portion 209 of the tool that blends smoothly into the outwardly bulging convex sidewall portion 208. The distal end 210 of the spout 206 is preferably situated roughly in line with the edge 205 of the base, as indicated by reference plane IX-IX. The distal end 210 of the spout 206 has an opening 212 thereat, which is sized to accommodate only one fusible bead 70. The spout 206 presents a tapering passageway that narrows towards the opening 212.

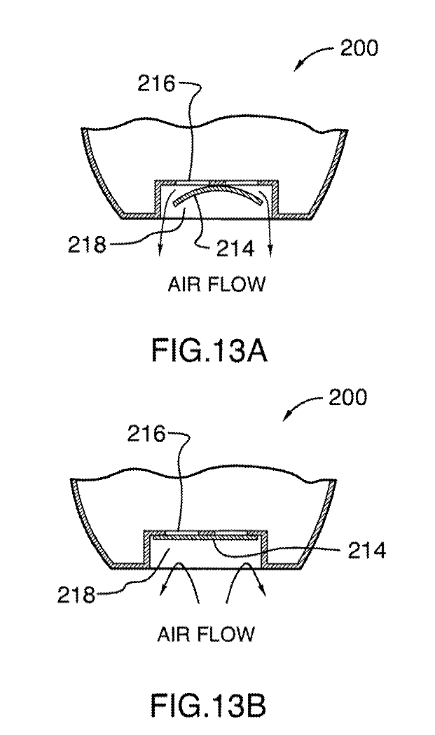

The base 204 include or otherwise incorporates a one-way air valve 214 thereat (FIGS. 13A and 13B). The valve 214 has an inlet 216 within the tool 200 and an outlet 218 external of the tool. In operation, the tool 200 may be squeezed, causing air to expel rapidly out of the tool via the one way valve 214 (FIG. 13B). This leaves a lower pressure area within the tool in comparison to the ambient, resulting in a suction force available at the opening 212 of the spout 206 as the deformable walls of the tool expand back to their original state after being compressed. This suction force may then be utilized to pick up one or more fusible beads, one at time, through the spout 206. The spout 206 and its opening 212 are configured to generate a selected air flow velocity with which to pick up building elements, so as to entrain fusible beads thereon. The one-way valve 214 prevents air flow back into the tool 200, however, so that air can only enter the tool via the opening 212.

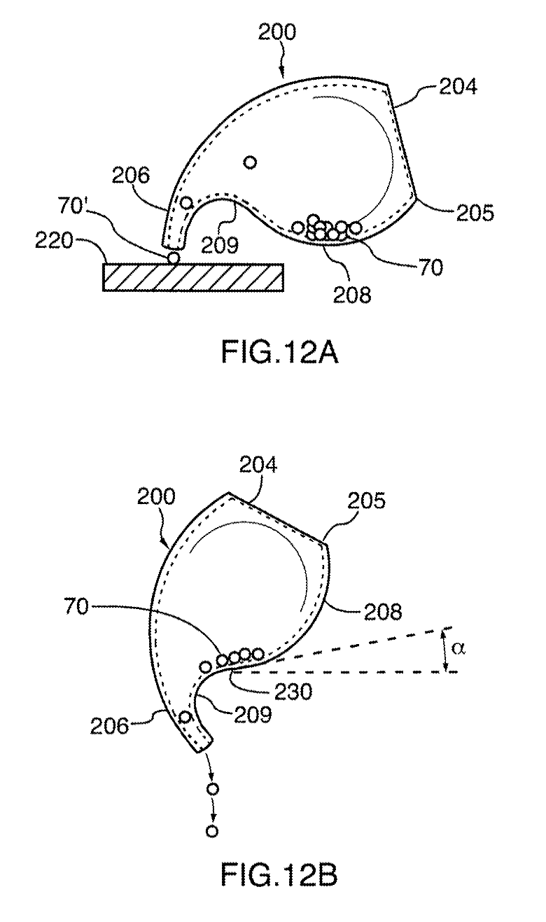

Referring additionally to FIG. 12A, in operation, the tool 200 may be manipulated so that when picking up a fusible bead 70 the spout 206 is directed downwardly towards a support or work surface 220. In this position the base 204 is generally perpendicular to the work surface 220 such that the outwardly bulging convex sidewall portion 208 of the tool 200 is disposed below the edge 205 of the base and any fusible beads 70 stored or entrained within the tool 200 are caught in a gravitational well defined by the outwardly bulging convex sidewall portion 208 and the inwardly directed concave sidewall portion 209. In this manner, external fusible beads 70′ may be sucked up without interference from the entrained fusible beads 70 and thereafter fall into the well.

Referring additionally to FIG. 12B, to dispense one or more of the fusible beads 70 stored in the tool 200, the tool 200 may be manipulated so as to further rotate the base 204 (in comparison to FIG. 12A) until it is generally parallel with the work surface 202. At a certain point of rotation the transitional portion 230 of the sidewall between the convex and concave sidewall portions 208, 209 will become horizontal. A slight further tilting of the tool 200 will enable the fusible beads 70 to pour out of the spout 206 as the convex and concave sidewall portions 208, 209 no longer present a gravitational well. The rapidity with which the fusible beads are poured out will be dependent on the degree of tilt (α) relative to the horizontal. It will also be appreciated that the user can dispense the fusible beads one at a time by moving the hand to and fro so that the transitional portion of the sidewall 230 moves above and below the horizontal, i.e., α is moved above and below zero degrees.

The moulds 20, 20′, 120, 120′ are preferably formed from transparent or clear material so as to enable the user to see how the fusible beads 70 are stacked or layered in the mould. In this manner, coupled with the pickup and dispensing tool 200, the user can control the placement of individual fusible beads so that, for example, certain body sections of the finished article are all of the same colour.

While the foregoing has described particular embodiments and variants of the invention, it will be appreciated that other modifications and variations may be made to the exemplary embodiments described herein without departing from the spirit of the invention.

1. A mould for creating a finished article from a plurality of adherent building elements, comprising:
a mould core;
at least one female mould portion surrounding the core so as to define a cavity between the core and the at least one female mould portion; and
at least one opening in at least one of the two female mould portion for ingress of adherent building elements into the cavity and introduction of a fusing agent in order to bond together the adherent building elements.

2. A mould according to claim 1, including one or more drainage holes for draining excess fusing agent out of the cavity.

3. A mould according to claim 2, wherein the adherent building elements are fusible beads and the fusing agent is a liquid.

4. A mould according to claim 3, wherein at a least a portion of the cavity is defined by an arrangement of raised elements having a spacing from one another that is selected to limit the amount of surface area of the mould that is in contact with the building elements through the fusing agent.

5. A mould according to claim 4, wherein the arrangement of raised elements is a series of ridges.

6. A mould according to claim 1, wherein the at least one female mould portion includes at least two female mould portions, and said at least one opening is a funnel formed when the at least two female mould portions are closed, the funnel fluidly communicating with the mould cavity and sized to enable the ingress of the adherent building elements into the cavity and for the introduction of the fusing agent into the mould cavity.

7. A mould according to claim 6, wherein each of the at least two female mould portions includes a frusto-conical section that, when the at least two female mould portions are closed, collectively define the funnel.

8. A mould according to claim 1 including a platform upon which the mould core is seated and each female mould portion is pivotably mounted to the platform.

9. A mould according to claim 8, wherein the core is removably mounted to the platform.

10. A mould according to claim 1 including a platform, and wherein the mould core is removably mountable to the platform such that, in operation, adhered building elements cover at least a portion of the mould core when it is removed from the mould.

11. A mould according to claim 10, including one or more drainage holes for draining excess fusing agent out of the cavity.

12. A mould according to claim 11, wherein the adherent building elements are fusible beads and the fusing agent is a liquid.

13. A mould according to claim 12, wherein walls defining the cavity include a series of ridges thereon.

14. A mould according to claim 13, wherein at least a portion of the ridges are orientated transverse to the opening and sized to distribute fusing agent across the breadth of the mould.

15. A mould according to claim 14, wherein at least a portion of the ridges are orientated generally parallel to the opening and sized to direct fusing agent towards the drainage holes.

16. A mould according to claim 10, wherein the at least one female mould portion includes at least two female mould portions, and said at least one opening is a funnel formed when the at least two female mould portions are closed, the funnel fluidly communicating with the mould cavity and sized to enable the ingress of the adherent building elements into the cavity and for the introduction of the fusing agent into the mould cavity.

17. A mould according to claim 16, wherein each of the at least two female mould portions includes a frusto-conical section that, when the at least two female mould portions are closed, collectively define the funnel.

18. A mould according to claim 17, wherein each of the at least two female mould portions is pivotably mounted to the platform.

19. A tool for picking up and dispensing small objects, comprising:
a resiliently deformable container having a spout with an opening leading to the interior of the container; and
a one-way air valve having an inlet within the container and an outlet external of the container, wherein the spout and its opening are configured to enable a suction force for picking up the small objects when the container expands back to its original state after being squeezed.

20. A tool according to claim 19, wherein:
the container has a base and a sidewall connected to the base;
the base defines an edge thereof;
the sidewall has a concave portion that bulges outwardly relative to the edge of the base; and
the sidewall has a concave portion extending inwardly relative to the edge of the base, the concave sidewall portion being connected to the convex sidewall portion and the concave sidewall portion defining at least a portion of the spout.

21. A tool according to claim 19, wherein the container presents a gravitational well at predetermined orientations of the container in order to preclude small objects entrained in the container from reaching the spout when the spout is directed gravitationally downwardly to pick up an external small object via said suction force.

22. A tool according to claim 19, wherein the gravitation well is not present at other orientations of the container so that entrained small objects may be dispensed out of the spout when the spout is directed gravitationally downwardly.
